(19) United States
(12) Patent Application Publication
(10) Pub. No.: US 2026/0264327 A1
(43) Pub. Date: Sep. 10, 2026

(54) Printing Device for Additive Manufacturing Processes, Including Screw Device for Material Supply

(71) Applicant: DiHeSys Digital Health Systems GmbH, Schwäbisch-Gmünd (DE)

(72) Inventors: Markus Dachtler, Ulm (DE); Gerald Huber, Plüderhausen (DE)

(21) Appl. No.: 19/091,069

(22) PCT Filed: Sep. 26, 2023
(86) PCT No.: PCT/EP2023/076619

§ 371 Date: Mar. 26, 2025

(30) Foreign Application Priority Data
Sep. 26, 2022 (DE) 202022002120.8

(51) Int. Cl. B29C 64/209; B29C 64/321; B33Y 10/00; B33Y 30/00

(52) U.S. Cl. CPC B29C 64/209; B29C 64/321; B33Y 30/00; B33Y 10/00

(57) ABSTRACT

A print head for additive manufacturing processes, the print head comprising a material feeding device having a material transport screw and a drive which can be inserted and changed flexibly and cost-effectively. The invention also relates to a printing device for additive manufacturing processes, which comprises at least one print head according to the invention.

### FIELD OF THE INVENTION

The present invention relates to a print head for additive manufacturing processes, the print head comprising a material feeding device having a material transport screw which is designed or configured, respectively, in such a way that the screw and its drive can be inserted and changed flexibly and cost-effectively. The invention also relates to a printing device for additive manufacturing processes, which comprises at least one print head according to the invention.

### BACKGROUND OF THE INVENTION

Print heads and corresponding printing devices for additive manufacturing processes in which particulate starting materials are used are known in the prior art.

Such print heads generally comprise a print nozzle and a device for feeding material into the print nozzle, typically having an extruder screw (also referred to herein as a “material transport screw”). Exemplary disclosures include US 2017/0008230 A1 and the review article on pellet extruders by Shaik et al. (2021) in Open Access Library Journal 8: e7698.

In additive manufacturing processes such as 2D and 3D printing, which generally involve computer-controlled positioning of the printing material on a printing table of the printing device, there is a challenge, particularly in the area of printing objects containing active ingredients in the pharmaceutical and/or food supplement sector, in that printing devices intended for the realization of an individualized supply of active ingredients should be as uncomplicated to set up and cost-effective to operate as possible.

The technical problem underlying the invention is to provide a print head and a printing device for additive manufacturing processes, which is/are manufactured cost-effectively with regard to the material feed and ensures a simple and variable supply of spare parts.

### SUMMARY OF THE INVENTION

The above technical problem is solved by the embodiments of the present invention disclosed in the claims as well as in the present description and the accompanying drawings.

In particular, the invention provides a print head for additive manufacturing processes comprising
a print nozzle and
a material feeding device having (i) at least one material transport screw configured to feed particulate printing material by rotational movement about its longitudinal axis into the print nozzle, and (ii) least one drive unit for the at least one material transport screw, wherein the at least one material transport screw has a proximal end driven by the drive unit, and a distal end, from which the printing material is transported into the printing nozzle, and wherein the at least one material transport screw (5) has a standard thread or a self-tapping thread at least on a section thereof which includes the distal end of the at least one material transport screw.

### BRIEF DESCRIPTION OF THE DRAWINGS

FIG. 1 is a front elevation view of a print head according to the invention.

FIG. 2 is right side partial cross-section view of the print head of FIG. 1;

FIG. 3 is a front and right side perspective exploded view of selected components of the print head of FIG. 1;

FIG. 4 is a front and right side perspective view of the components of the print head of FIG. 3.

FIG. 5 is a front and right side perspective view of the components of the print head of FIG. 3.

FIG. 6 is a front and right side perspective view of the components of the print head of FIG. 3.

FIG. 7A is a top plan view of a pharmaceutical product manufactured using the print head of FIG. 1.

FIG. 7B is a side elevation view of the pharmaceutical product of FIG. 7A.

### DETAILED DESCRIPTION OF THE INVENTION

The invention provides a print head for additive manufacturing processes comprising:
a print nozzle, and
a material feeding device having (i) at least one material transport screw configured to feed particulate printing material by rotational movement about its longitudinal axis into the print nozzle, and (ii) least one drive unit for the at least one material transport screw, wherein the at least one material transport screw has a proximal end driven by the drive unit, and a distal end, from which the printing material is transported into the printing nozzle, and wherein the at least one material transport screw (5) has a standard thread or a self-tapping thread at least on a section thereof which includes the distal end of the at least one material transport screw.

The print head according to the invention may comprise more than one print nozzle and more than one material feed device, each having one of the material transport screws defined according to the invention and its drive unit.

The print head and the further embodiments of the invention is/are preferably configured for additive manufacturing by hot melt extrusion (HMT), more preferably by FDM (filament deposition modeling). Particularly preferably, the print head according to the invention and the further embodiments of the invention are designed for the additive manufacturing, preferably by FDM, of pharmaceutical, nutraceutical and/or food supplement products, in particular dosage forms, more preferably oral dosage forms.

Preferably, the material transport screw has a thread, i.e. a standard thread or self-tapping thread, with a core diameter of 2.0 to 30 mm.

In preferred embodiments, the proximal end of the material feed screw has a shape and/or at least one recess designed for driving the material transport screw by the drive unit.

The proximal end of the material transport screw preferably comprises a screw head preferably having a mean diameter larger than the outer diameter of the other parts of the material transport screw. More preferably, the screw head has a shape and/or at least one recess designed for driving the material transport screw by the drive unit.

Preferably, the length of the thread or the total length of the material transport screw or the length of the material transport screw without the screw head, if present, is about 30 mm to about 100 mm, more preferably about 40 mm to about 90 mm.

In certain embodiments of the invention, the end or the end region, respectively, of the material transport screw opposite the screw head can be conical or otherwise tapered. This is particularly preferred for self-tapping material transport screw threads.

In further preferred embodiments, the outer diameter of the screw thread (excluding any conically tapered or otherwise tapered end portion, if present) is about 4.0 to about 5.0 mm. In certain embodiments, the core diameter of the screw thread may be about 2.0 to about 4.0 mm. In further preferred embodiments, the flank angle of the threaded screw may be about 30° to about 80°, preferably about 55° to about 65°, most preferably about 60°. In further embodiments, the lead angle is about 2° to about 50°, in other embodiments about 5° to about 50°, most preferably about 3°. In further certain embodiments of the invention, the pitch of the screw thread is about 0.4 mm to about 4.0 mm. In certain embodiments of the invention, the screw thread may have a thread depth of about 0.25 mm to about 3.0 mm. In further embodiments, the screw thread width of the screw thread may be about 0.1 mm to about 2.0 mm.

According to the invention, the term “standard thread” means an essentially standardized thread whose parameters are subject to a national or international standard. Preferably, the standard thread is selected from metric or inch standard threads. Preferred standard threads correspond to the metric ISO standard thread according to the valid, i.e. current version of DIN 13-1, preferably DIN 13-1 (1999-11). More preferably, the thread is selected from the sizes M2 to M20, in particular from M2, M2.5, M3, M3.5, M4, M4.5, M5, M5.5, M6, M7, M8, M9, M10, M11, M12, M13, M14, M15, M16, M17, M18, M19, M20, according to DIN 13-1 in the valid, i.e. current version, preferably DIN 13-1 (1999-11). In other embodiments of the invention, the standard thread is a standard inch thread according to ASME/ANSI B1.1 in the respectively valid, i.e. current version, preferably according to ASME/ANSI-B1.1 1989 (R2003). More preferably, the thread is selected from sizes #3-64 UNC, #4-40 UNC, #5-40 UNC, #6-32 UNC, #8-32 UNC, #10-24 UNC, #12-24 UNC, ¼″-20 UNC, 5/16″-18 UNC, ⅜″-16 UNC, 7/16″-14 UNC, ½″-13 UNC, 9/16″-12 UNC, ⅝″-11 UNC, ¾″-10 UNC, ⅞″-9 UNC, 1″-8 UNC according to ASME/ANSI B1.1 in the respectively valid, i.e. current version, preferably according to ASME/ANSI-B1.1 1989 (R2003). In other embodiments of the invention, the thread can also be a Whitworth thread, with ¼″ to ¾″ Whitworth threads being preferred.

In the case of a material transport screw having a self-forming thread (also referred to as a self-tapping thread), wood screw threads are preferably used. Preferred wood screw threads for use in the present invention are also standardized wood screw threads, more preferably metric wood screw threads. More preferred are metric wood screw threads according to DIN 7988 in the currently valid, i.e. latest version. Wood screw threads according to DIN 7988 (1975-2) are particularly preferred. In particularly preferred embodiments, the wood screw thread is selected from H3 to H20, including H3, H3.5, H4, H4.5, H5, H5.5, H6, H7, H8, H10, H12, H16, H20, in accordance with DIN 7988 in the respective currently valid, i.e. latest version, most preferably DIN 7988 (1975-2).

In preferred embodiments of the invention, the flanks of the thread, preferably of the standard thread or of the self-tapping thread, respectively, of the material transport screw, are configured such that the flanks, at least at or in the vicinity of the location where they meet (i.e. the location where the legs of the thread flanks meet or in the vicinity thereof), at least on the thread outsides, do not have an acute angle to one another. Thus, the end of the flanks, i.e. where the legs of the flank meet or converge, at least in the region of the flank ends, are flattened and/or rounded compared to an otherwise essentially identical material transport screw. Such embodiments have the particular advantage of at least reducing, preferably essentially preventing, material abrasion or loss at the flank ends or where a certain contact of the flank ends (in particular at or near the location where the legs of the flanks meet) to the usually present existing feed housing or to the feed screw channel therein, respectively, usually accommodating the material transport screw. The reduction or avoidance, respectively of material abrasion preferably concerns the flank ends and/or the feed housing or the feed channel accommodating the material transport screw, more preferably both. A reduction in material abrasion or loss in this context means that the material abrasion or loss is preferably reduced by at least approximately about 30%, more preferably by at least about 40%, further preferably by at least about 50%, still more preferably by at least about 60%, still at least more preferably by at least 70%, still more preferably by at least about 80%, yet more preferably by at least about 90%, most preferably by at least about 95% compared to a material transport screw, preferably an otherwise essentially identical material transport screw, which does not have flattened and/or rounded flank ends as described above It is apparent to a person skilled in the art that the percentage reduction in material abrasion and/or loss is set in relation to a defined operating or usage period of the respective unit (material transport screw and/or feed housing or feed channel located therein, which accommodates the material transport screw), being subject to the material abrasion or material loss. Corresponding time periods can be selected, for example, from a defined number of operating hours or hours of use, such as about 10 hours, about 50 hours, about 100 hours, about 200 hours or about 500 hours or more, such as about 1000 hours. In another embodiment, the reduction in material abrasion and/or material loss can also be determined with respect to an object printed with the aid of the print head or printing device of the invention, by analyzing printed objects with respect to material present stemming from the transport screw and/or the feed housing or feed channel, wherein corresponding amounts of the abrasion or loss material are usually expressed as units of mass such as ng, μg, mg or grams per printed object, or as a multiplicity of printed objects such as about 100, about 200, about 500 or more objects such as about 1000 or about 2000 objects or more.

In preferred embodiments of this type, the flanks or flank ends of the standard thread or the self-tapping thread are at least approximately trapezoidal, conical or spherical or are shaped in this way. Regarding trapezoidal thread flanks, it is also preferred that the corners of the trapezoidal flank (on the outside) are rounded.

In further preferred embodiments of the invention of the aforementioned type, the standard thread of the material feed screw (5) is selected from M5 to M20 in accordance with DIN 158-1 (1997-06).

In connection with the above-described design of the material transport screw thread for reducing or preventing material abrasion and/or loss, in particular on the flanks of the thread and/or at the contact locationts with the feed housing or its channel for receiving the material transport screw, the person skilled in the art understands, or it is understood in this sense by the term standard thread or self-tapping thread, that such threads are also standard or self-tapping threads, at least insofar as these threads, with the exception of the rounded or flattened ends of the thread flanks, are otherwise self-tapping threads, at least insofar as these threads, with the exception of the rounded or flattened ends of the thread flanks, otherwise correspond to, in particular with regard to the parameters according to a national or international standard, a conventional standard thread or self-tapping thread.

The above-mentioned reduction or even substantial prevention of material abrasion or loss is particularly important with regard to the use of print heads and/or printing devices and/or kits according to the invention for the additive manufacturing, preferably by an additive manufacturing method according to the invention, of pharmaceutical, nutraceutical and/or food supplement products, in particular dosage forms, more preferably oral dosage forms, because such objects are administered to users, and, according to the invention, contamination by such material abrasion and/or loss should at least be reduced or prevented.in objects of that kind whenever possible.

According to the invention, it is preferable to use standard screws as material transport screws, preferably having a thread as described in the preceding paragraph, which combines a particularly high availability with a cost-effective price in the manufacture of a print head equipped in this way as well as in its maintenance. Such screws are available in large numbers and in a wide range even in DIY stores. In the field of additive manufacturing of pharmaceutical, and/or nutraceutical and/or food supplement products, in particular dosage forms, more preferably oral dosage forms, the screw should entirely, at least in any case the part of the screw that is in contact with the printing materials, i.e. usually the threaded part of the material transport screw, consist of or comprise a high-quality steel which may be required for approval for the production of pharmaceutical and/or nutraceutical and/or food supplement products. Examples of materials that can be used in afore-mentioned applications are high-quality steels such as V2A and V4A, particularly preferred steels of steel group numbers 1.43, 1.44 and 1.45 according to DIN EN 10027-1/-2 in the respective valid, i.e. current version.

If the proximal end of the material screw has a screw head, the shape of the head of the material transport screw is preferably selected from lens head, plate head, countersunk head (including lens countersunk head, countersunk milling head and trumpet head), hexagon head, round head (sometimes also referred to as half-round head), pan head and cylinder head.

The choice of material transport screw, particularly with regard to shape and thread, will depend on the type and size of the printing material to be used, such as pellets, granules or powder.

In preferred embodiments, the drive shape, i.e. the way in which the proximal end of the material screw, preferably the screw head, is shaped so that the drive element of the drive unit can engage form-lockingly or drive-lockingly in the screw head (in particular through suitable recesses in the screw head) or on the screw head (in particular through the external shape of the screw head) is selected from external hexagon socket, internal hexagon socket, slotted, crosshead, Pozidriv®, hexalobular socket (also called Torx®), Mortorq®, Torx-Plus®, LocTec® and Secloc® drives. Particularly preferred drives are hexalobular or Torx®, respectively, or Torx-Plus® drives. In other embodiments of material transport screws that can be used according to the invention not having a screw head, the proximal end of the screw also has a drive designed such that the drive unit engages in a form-locking or drive-locking manner in one or more recesses at or in the proximal end of the material transport screw, or the shape of the proximal end (or of a correspondingly designed proximal end area of the material transport screw) is configured in such a way that the drive unit can engage form-lockingly or drive-lockingly with the proximal end or with the proximal end area of the material transport area. In preferred embodiments, wherein the drive is preferably selected from external hexagon socket, internal hexagon socket, slotted, crosshead, Pozidriv®, hexalobular socket (also called Torx®), Mortorq®, Torx-Plus®, LocTec® and Secloc® drives. Particularly preferred drives are hexalobular or Torx®, respectively, or Torx-Plus® drives.

The drive unit of the print head according to the invention preferably has a drive element which engages form-lockingly or drive-lockingly with the proximal end of the material transport screw, preferably engaging with the screw head. Particularly preferably, the drive element is detachably connected to the drive unit, more preferably the drive element is detachably connected to the drive device by a change mechanism. Such embodiments can be realized, for example, by so-called bits, which are detachably fastened in a corresponding receptacle of the drive device. Typically, such bits are held in the receptacle by a spring element. In other embodiments, the change mechanism can also be provided by a clamping device such as a drill chuck or the like.

The print head according to the invention preferably comprises means for receiving the particulate printing material, preferably pellets, granules or powder, before it is fed to the material feeding device, and preferably also a configuration or mechanism for feeding or introducing the printing material into the material feeding device. Funnel-like embodiments typically provided with a suitable closing and opening mechanism may be used in certain embodiments. In other embodiments, a transport screw or auger can also be used in the case of the material container to feed the printing material to the material feeding device.

The print head according to the invention, in the present case an extrusion print head, comprises further generally used components for additive manufacturing processes, which in the context of the invention is preferably characterized as an FDM (filament deposition modeling) process, such as a print nozzle (also referred to as an extrusion nozzle). Another common component is a heating device, preferably provided upstream of the printing nozzle, for heating the typically solid or semi-solid printing material into an extrudable form. In a preferred embodiment, the print head can also have cooling mechanisms, such as cooling fins, for dissipating or regulating, respectively, the generated heat. Cooling agents can also circulate in cooling devices which can be used according to the invention.

The drive unit typically comprises a motor, which in certain embodiments can be designed as a stepper motor. In other embodiments, the motor can also generate a continuous movement. In any case, the drive unit ensures a rotary movement which is transmitted to the material transport screw via a drive element. The drive unit is preferably configured in such a way that it the drives the material transport screw around its longitudinal axis at about 2 to about 20, more preferably at about 2 to about 12 revolutions per minute (rpm).

In a further aspect, the invention provides a kit or article comprising
at least one print head (1) for additive manufacturing processes comprising a print nozzle (2) and a material feeding device configured to receive at least one material transport screw (5), and a drive unit (9) for the at least one material transport screw (5), and
at least one material transport screw (5) configured to move particulate printing material by rotational movement about its longitudinal axis into the printing nozzle (2) when the material transport screw is arranged in the material feeding device, the at least one material transport screw having a proximal end driven by the drive unit and a distal end from which the printing material is transported into the printing nozzle (2) when the at least one material transport screw is arranged in the material feeding device,
   wherein the at least one material transport screw (5) has a standard thread or a self-tapping thread at least on a section thereof which includes the distal end of the material screw.

A further kit of the invention comprises the print head as defined with the material transport screw arranged therein and at least one further material transport screw according to the definition of the invention, wherein the further material transport screw(s) can be the same or different, that being valid with respect to each other as well as with respect to the material transport screw already arranged in the print head according to the invention.

The print head according to the invention can thus also be as provided as a kit (also referred to as an “article”) together with one or more material transport screws and/or together with one or more drive elements, preferably in the form of bits, adapted to the drive type of the material transport screw(s), which can be detachably connected to the drive unit, preferably by means of an exchange mechanism.

The kit can comprise screws having the same or different threads and/or lengths and/or screw heads and/or drives types. Optionally, the kit can comprise the same or different drive elements adapted to the drive type(s) of the material transport screw(s).

As already elaborated above, kits according to the invention can be designed such that the at least one print head is already provided with a material screw arranged therein. Alternatively, as defined in more detail above, the kit includes at least one print head as described above without a material transport arranged therein and at least one material transport screw as described above, this type of kit also comprising one or more drive elements adapted to the drive type of the material transport screw(s), wherein the drive element(s), preferably in bit form, can be detachably connected to the drive device, preferably by an exchange mechanism.

Preferred embodiments of the material transport screw(s) of the kits according to the invention are as set forth above.

The invention also relates to a printing device for additive manufacturing processes, comprising one or more print heads of the invention and a printing bed comprising a printing table having a printing surface.

In addition, the printing device preferably includes further usual elements and devices being typical and/or advantageous for 2D and/or 3D printing devices. In particular, the at least one print head and/or the print table is/are movable by suitable, in generally electric, servomotors so that the position of the print head (or print heads) or at least of the print nozzle (or print nozzles) is changeable relative to the printing surface in the spatial axes x, y and z.

In a preferred embodiment of the invention, the printing device comprises a unit for preferably automatically calibrating the position of the printing nozzle(s), in particular an optical device for capturing an image of the printing nozzle(s) of the printing device. In this regard, it is referred to the disclosure content of the document DE 20 2021 003 596 U1.

Preferably, the printing device of the invention comprises a computerized control unit configured for moving and detecting the position of the print table and/or.at least the print nozzle of the print head or the print nozzles of the print heads, respectively.

Furthermore, the printing device preferably comprises a computerized image processing unit designed to display and process the image data of the printing nozzle(s) generated by the optical device.

It is also preferred that the printing device comprises a computer unit configured to correlate the image data of the computerized image processing unit and the position data of the computerized control unit. In particular, the computer unit is configured to measure and store differences in positional data at least in the x-y direction (i.e. horizontal position data), preferably also in the z direction (i.e. vertical position data).

In preferred embodiments of the invention, the printing device includes at least one device for analyzing the additive manufacturing process, in particular 2D and/or 3D printing, carried out with the printing device and/or the object produced with the aid of the device.

Preferably, the printing device comprises at least one device for spectroscopic measurement of material applied to the printing surface. In particularly preferred embodiments, this device is a device for infrared spectroscopic measurement, more preferably an NIR (near infrared) device. In other embodiments, a Raman spectroscopic device is used, wherein Raman spectroscopy and infrared spectroscopy (more preferably NIR spectroscopy) can be used simultaneously or sequentially, in which case the device according to the invention both comprises a device for Raman spectroscopy and a device for infrared spectroscopy, more preferably for NIR spectroscopy.

In a further embodiment of the invention, the print head(s) each comprise/comprises a device for measuring the flow rate of material flowing into the print head and/or through the print head or through the print nozzle, respectively. In preferred embodiments, the flow rate is measured by means of a magnetic-inductive flow measuring unit. According to the invention, a device for flow measurement is preferably used in printing devices of the invention which are particularly designed for 2D printing or at least for 2D printing, respectively.

In a further embodiment, the printing device includes a device, preferably an infrared camera, for recording a thermal image of material coming out of the printing nozzle(s) and/or of material applied to the printing surface.

Furthermore, the print head(s) may comprise a device for inductive flow measurement.

In a further preferred embodiment, the printing table comprises a weighing device.

Preferably, the printing device according to the invention includes a preferably computerized device for recording, handling and monitoring the process data collected with the aid of the above process analysis devices. This device is also referred to below as a process monitoring device. Furthermore, and preferably, this computer-aided process monitoring device is connected, preferably via data exchange and/or data transmission and/or data receiving devices, to the aforementioned computer-aided control, image processing and computer units so that the process parameters obtained via the process monitoring device(s) can be integrated.

Typically, and preferably according to the invention, the method according to the invention is carried out in a computerized or computer-assisted manner, particularly preferably using the computer-assisted control nd/or image processing and/or computer unit already detailed above.

Also disclosed is an additive manufacturing method, preferably for 2D and/or 3D printing, for producing an object, preferably an active agent containing object, preferably pharmaceutical and/or nutraceutical and/or dietary supplement dosage forms, preferably for oral administration, comprising the step of printing a particulate printing material, such as pellets, granules and/or powder, using the printing device according to the invention.

Furthermore, the printing method is preferably carried out using one or more of the aforementioned devices for analyzing the manufacturing process.

There is also disclosed a method for producing a particulate printing material, preferably pellet, granular or powder printing materials, which in preferred embodiments can be carried out upstream of the additive manufacturing method. Preferably, the printing material comprises at least one pharmaceutical and/or at least one nutraceutical and/or at least one dietary supplement active ingredient, usually in at least one pharmaceutically acceptable and/or nutraceutically acceptable and/or dietary supplement compatible carrier.

The method for producing the particulate printing material comprises the steps of
producing a filament-shaped printing material blank; and shredding the printing material blank.

In a preferred embodiment, the filament-shaped printing material blank, also referred to herein as printing material filament, is produced in a suitable manner by extrusion, preferably hot melt extrusion (HME), from the starting substances or materials, respectively. The particle size of the printing material to be produced can be determined at least in two dimensions by selecting the diameter of the filament. The shredding can be carried out, for example, by cutting the blank. Of course, any mechanical or other comminution processes can be selected and combined with each other. The process can also include a size selection or sorting step. For example, the material obtained after shredding can be screened according to the corresponding grain sizes. Shredding and sorting can also be combined in preferred embodiments, for example by rasp screening, usually using commercially available equipment.

The present invention is outlined below in more detail with reference to the accompanying drawings in exemplary, non-limiting embodiments:

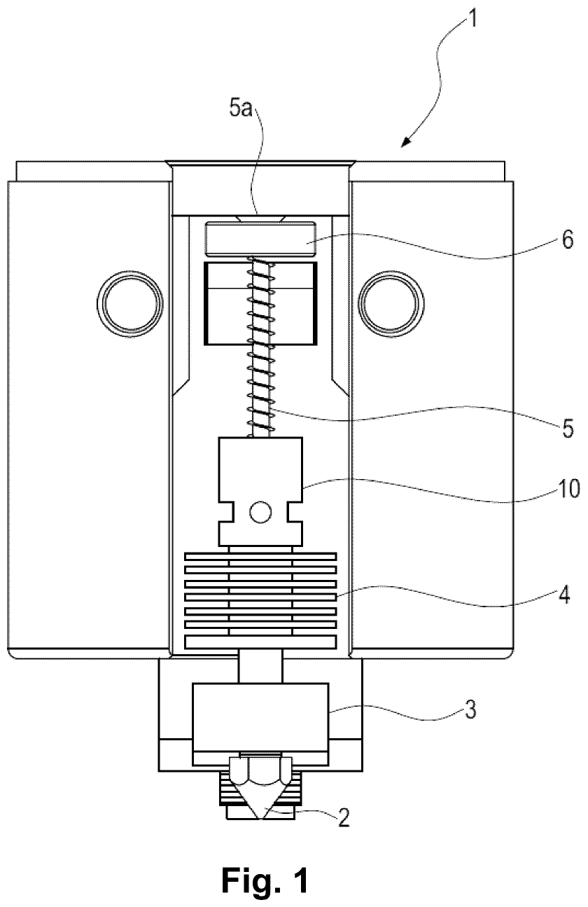

FIG. 1 shows a schematic representation of a front view of a print head according to the invention. The relevant components of the print head (1) are described below with reference to FIG. 1 from the bottom (also referred to as “distal” in the present disclosure in relation to the end of the material transport screw connected to the drive unit) to the top (also referred to as “proximal” in the present disclosure in relation to the end of the material feed screw connected to the drive unit). The print head 1 of this embodiment has a print nozzle 2. The particulate printing material, preferably pellets, granules or powder, is heated by a heating device 3 for converting the printing material into a flowable state. For preventing the system from overheating, print head 1 is equipped with a cooling device 4, which preferably includes cooling fins through which cooling liquid flows, as illustrated in the present embodiment with reference to FIG. 1. A feed chamber 10 is arranged above cooling device 4, which chamber in the present view conceals a part of the screw 5, whereby in this area the printing material is fed into the screw chamber (also referred to as the transport or extruder chamber) which may be accomplished, for example, via a funnel-shaped configuration that is typically provided with an opening/closing mechanism. The material transport screw 5 extends above the feed chamber 10, which also may serve as a guide element for the screw 5, and is supported directly below the screw head by a screw holder 6, in which the screw 5 directly below the screw head 5a, in this case a countersunk head, is centered and can be rotated about its longitudinal axis.

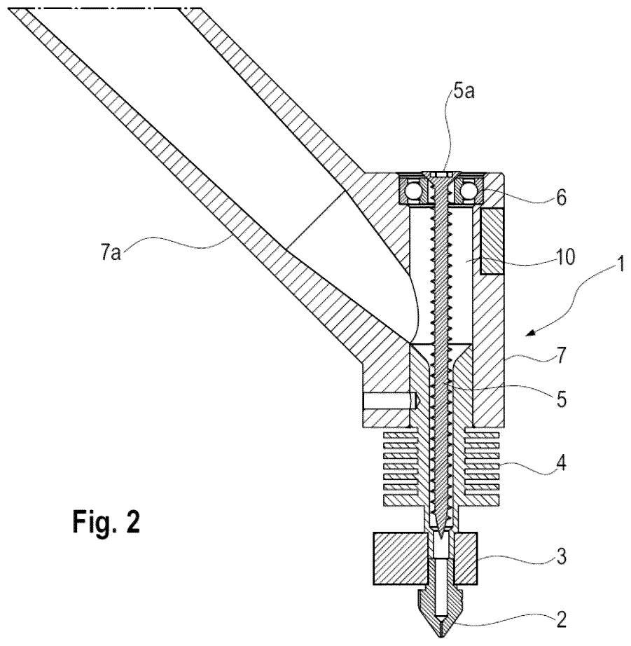

FIG. 2 shows a schematic representation of the essential elements of the print head 1 according to the invention in lateral cross-sectional view, whereby a housing that is usually present is not shown for the sake of clarity. From the bottom (distal) to the top (proximal), the cross-sectional view shows a printing nozzle (proximally) followed by the heating device 3. The distal end or the distal end region, respectively, of the material transport screw 5 is conically tapered and terminates in the transition to the heating device 3. The material transport screw 5 extends in a transport chamber (also denoted as extruder chamber), which begins just above the heating device and extends distally (here: to the top) to the feed chamber 10. Above this (proximally) follows the feed chamber 10, into which the printing material, preferably pellets, granules and/or powder, is fed via dispensing device 7a. Screw 5 extends further upwards (proximally) through feed chamber 10 and is supported in the region of its upper (proximal) end by the holder 6 so as to be centered and rotatable about its longitudinal direction. In the present embodiment, holder 6 encompasses a part of the screw thread and a part of the screw (countersunk) head 5a. In the embodiment shown, dispensing device 7a, feed chamber 10, screw holder 6 and approximately the upper (proximal) part (i.e. behind the cooling device in the proximal direction) of the transport chamber are arranged in a feed housing 7. Except for the screw head 5a the material transport screw 5 is provided with a self-tapping thread.

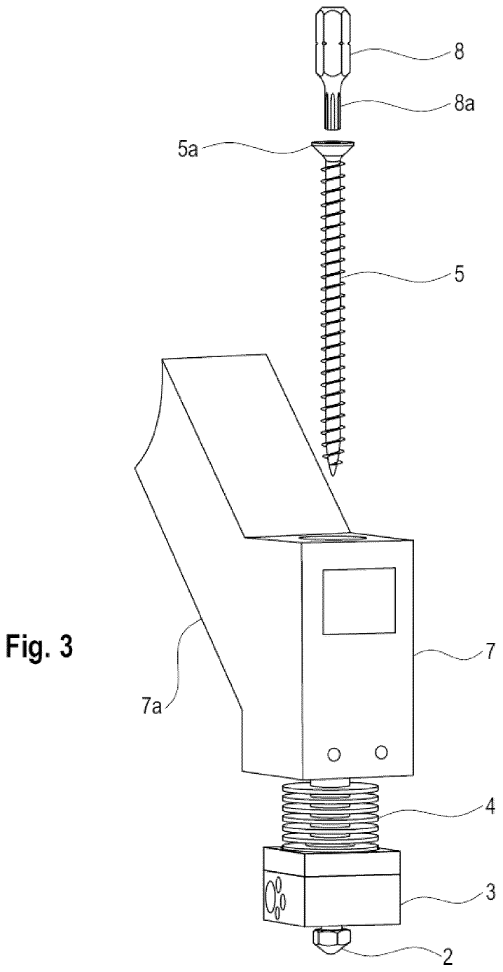

FIG. 3 shows a schematic representation of individual parts of the print head according to the invention, wherein the material transport screw 5, which comprises a Torx® countersunk head 5a, and the drive element, which comprises a Torx® screw drive 8a, have not yet been inserted into the feed housing 7, in which, as described above with reference to FIG. 2, dispending device 7a, feed chamber 10, screw holder 6 and approximately the upper (proximal) part (i.e. in the proximal direction above the cooling device) of the transport chamber are arranged. The drive element 8 with screw drive 8a is designed as a bit enabling the type of drive and type of screw to be exchanged rapidly.

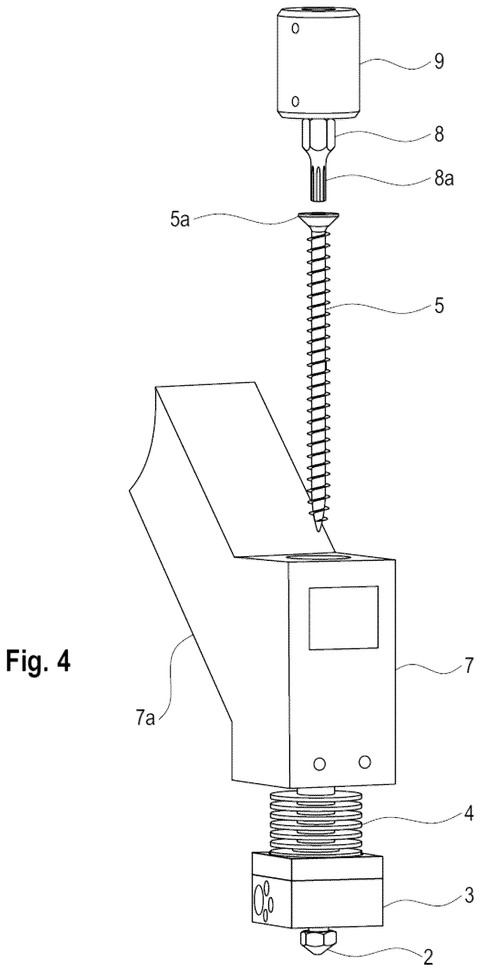

FIG. 4 shows a further schematic representation of the elements of FIG. 3, wherein drive element 8 including Torx drive 8a is inserted into the drive unit 9.

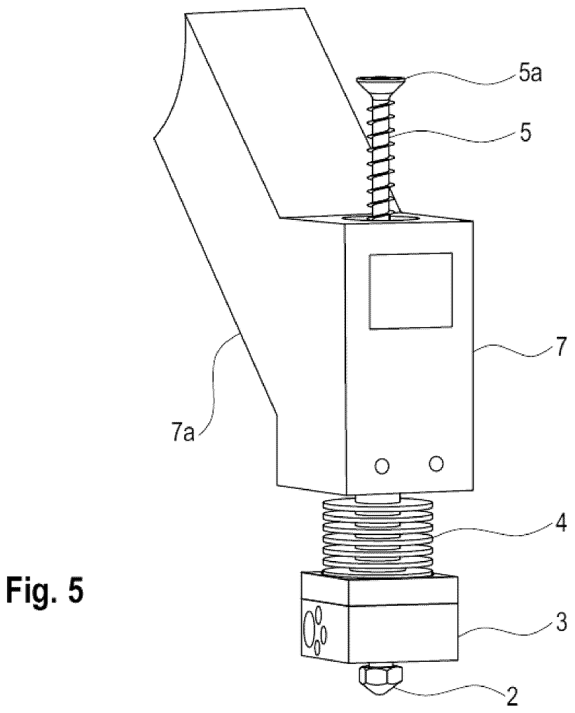

FIG. 5 shows a schematic representation of a material transport screw inserted into the transport chamber located in the feed housing 7.

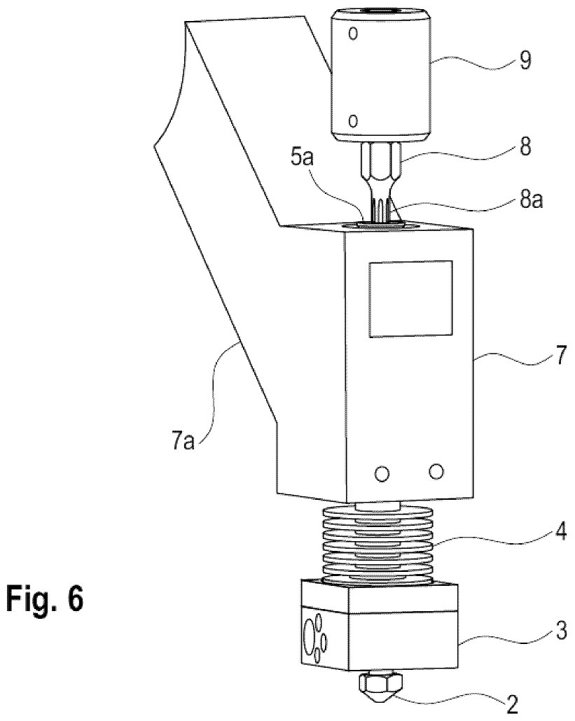

FIG. 6 shows a further schematic representation of the elements of the print head as shown in FIG. 1 in the assembled state. In particular, it can be seen how the Torx® drive 8a of the drive element 8 engages form-fittingly with the corresponding Torx® recesses of the countersunk head 5a of material transport screw 5.

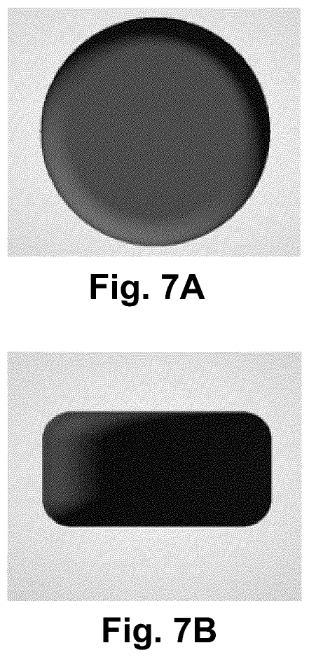

FIG. 7 shows an oral dosage form of metoprolol succinate printed using the embodiments according to the invention, in this case a biplanar object in the form of a tablet. (A) Top view of the printed tablet. (B) Side view of the printed tablet.

The present invention is further illustrated with reference to the following non-limiting example.

### EXAMPLE

Using a printing device according to the invention, two different metoprolol succinate formulations (A and B) were printed by FDM in tablet form.

Both formulations were initially produced by three-stage tumbler mixing. Thereafter, hot-melt extrusion was carried out using a laboratory extruder (ZE HM99, Three Tec GmbH, Sion, Switzerland) from powdered raw materials using a die diameter of 2 mm. The extrusion temperature was 100° C. for formulation A and 140° C. for formulation B. The extrudate strands were shredded by rasp sieving using a U5 Comil® device (Quadro Engineering Corp., Waterloo, CA) at 250 rpm to obtain granules having a particle size of 1 to 2 mm in diameter.

Table 1 below shows the ingredients and their proportions (in % by weight, based on the total weight of the respective formulation) of formulations A and B.

TABLE 1
Composition of formulations A and B

| | MSN | KVA64 | EPO | PEG |
|---|---|---|---|---|
| | [% by | [% by | [% by | [% by |
| Formulation | weight] | weight] | weight] | weight] |
| A | 25 | 65 | — | 5 |
| B | 25 | — | 75 | — |

MSN: Metoprolol succinate (pharmaceutically active ingredient)
KVA64: Kollidon VA64 (vinylpyrrolidone-vinyl copolymer acetate; carrier polymer)
EPO: Eudragit E PO (anionic copolymer of methacrylic acid and methyl methacrylate; carrier polymer)
PEG: Lixopol 6000 (polyethylene glycol; plasticizer)

The parameters of the extrusion screws (material transport screws) used were varied as shown in Table 2 below. The screws can process both granules and powder.

TABLE 2
Parameters (ranges) of the extrusion screws used.

| Properties | Parameter value (range) |
|---|---|
| Number of screws in the extrusion channel | 1 |
| Screw length [mm] | 40-90 |
| Outer screw diameter [mm] | 4.0-5.0 |
| Screw outer core diamater [mm] | 2.0-4.0 |
| Screw pitch angle [°] | 5-50 |
| Screw pitch [mm] | 1.0-4.0 |
| Screw channel depth [mm] | 0.5-3.0 |
| Screw thread width [mm] | 0.1-2.0 |

From the obtained granulates tablets were printed by FDM using a print head of the invention as a component of a printing device according to the invention. The printing throughput at the printing nozzle (printing volume per time unit) was 1.131 mm3/s and the speed of the printing nozzle movement was 25 mm/s. The printing temperatures varied between 140° C. and 160° C. The temperature of the printing surface of the printing table was 50° C. An exemplary dosage form obtained by the printing process is shown in FIG. 7A (top view) and 7B (side view).

### LIST OF REFERENCE SIGNS

1 Print head
2 Printing nozzle
3 Heating device
4 Cooling unit
5 Material transport screw
5a Head
6 Screw holder
7 Feed housing
7a Dispensing device
8 Drive element
8a Screw drive
9 Drive unit
10 Feed chamber

1. A print head for additive manufacturing processes, comprising
a printing nozzle, and
a material feeding device having (i) at least one material transport screw configured to feed particulate printing material by rotational movement about its longitudinal axis into the print nozzle, and (ii) least one drive unit for the at least one material transport screw,
wherein the at least one material transport screw has a proximal end, which is driven by the drive unit, and a distal end, from which the printing material is transported into the printing nozzle, and
wherein the at least one material transport screw has a standard thread or a self-tapping thread at least on a section thereof at the distal end of the at least one material transport screw.

2. The print head of claim 1, wherein the thread of the material transport screw has a core diameter of 2.0 to 30 mm.

3. The print head of claim 1, wherein the proximal end of the material transport screw has a shape and/or at least one recess configured to mate with the drive unit whereby the drive unit can drive the material feed screw.

4. The print head according to claim 1, wherein the length of the thread of the material transport screw is 30 mm to 100 mm.

5. The print head according to claim 1, wherein the material transport screw has a standard thread selected from M2 to M20 according to DIN 13-1 (1999-11).

6. The print head according to claim 1, wherein the material transport screw has a self-tapping thread which is a wood screw thread.

7. The print head of claim 6, wherein the wood screw thread of the material transport screw is selected from H3 to H20 according to DIN 7988 (1975-02).

8. The print head of claim 1, wherein the flanks of the standard thread or of the self-tapping thread of the material feed screw are at least approximately trapezoidal, conical or spherical.

9. The print head of claim 1, wherein the material transport screw has a standard thread selected from M5 to M20 according to DIN 158-1 (1997-06).

10. The print head according to claim 3, wherein the proximal end of the material transport screw comprises a screw head having a shape and/or at least one recess adapted to be driven by the drive unit.

11. The print head of claim 10, wherein the shape of the screw head is selected from lens head, disk head, countersunk head, square head, hexagon head, round head, pan head and cylinder head.

12. The print head according to claim 3, wherein the proximal end of the material screw transport has ted to a drive type selected from external square, internal square, external hexagonal, internal hexagonal, slotted, cross-slotted, Pozidriv, internal hexalobular, external hexalobular, Mortorq, Torx-Plus, LocTec and Secloc drives.

13. The print head according to claim 3, wherein the drive unit comprises a drive element which form-fittingly engages on or engages with proximal end of the material feed screw.

14. The print head of claim 13, wherein the drive element is detachably connected to the drive unit.

15. The print head of claim 14, wherein the drive element is detachably connected to the drive unit via a change mechanism.

16. The print head of claim 15, wherein the drive element is designed as a bit and the drive device has a recess configured to form-fittingly receive the bit.

17. A printing device for additive manufacturing processes comprising:
one or more print heads according to claim 3; and
a printing bed including a printing table having a printing surface.

18. A kit containing:
at least one print head for additive manufacturing processes, comprising a print nozzle and a material feeding device adapted to receive at least one material feed screw, and a drive unit for the material transport screw, and
at least one material transport screw configured to feed particulate printing material by rotational movement about its longitudinal axis into the printing nozzle when the material transport screw is arranged in the material feeding device, wherein the material transport screw has a proximal end driven by the drive unit and a distal end from which the printing material is transported into the printing nozzle when the material transport screw is arranged in the material feeding device;
wherein the material transport screw has a standard thread or a self-tapping thread at least on a section thereof which includes the distal end of the material transport screw.

19. (canceled)

20. (canceled)

21. An additive manufacturing method for 2D and/or 3D printing an object, the method comprising the step of printing a particulate printing material, using the printing device of claim 17.
